(19) United States
(12) Patent Application Publication
(10) Pub. No.: US 2007/0268205 A1
(43) Pub. Date: Nov. 22, 2007

(54) MULTIPRIMARY COLOR DISPLAY

(75) Inventor: Daisuke Sasaguri, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/744,989

(22) Filed: May 7, 2007

(30) Foreign Application Priority Data
May 19, 2006 (JP) 2006-140881

(51) Int. Cl. G09G 3/00

(52) U.S. Cl. 345/30

(57) ABSTRACT

A display displays a color image by using a light source of at least four or more primary colors, and at least one color of the light source is yellow. Thus, it is possible to provide a flat panel display that can acquire a wider color reproduction range without sacrificing luminance.

### BACKGROUND OF THE INVENTION

1. Field of the Invention

The present invention relates to a multiprimary color display.

2. Description of the Related Art

In recent years, a conventional type image display device (simply called a “display” hereinafter) is being replaced with a flat panel display in fields from personal computers to at-home TV receivers.

More specifically, flattening of the display first began in the field of personal computers, and in this field the conventional-type display was replaced with a liquid crystal display.

However, although performance of the liquid crystal display has been improved, some problems still occur in regard to the field angle, color reproducibility (including color reproducibility in an oblique direction to the screen), black displaying, and response speed. In a plasma display, it is difficult to make pixels minute because of the space required for generating the plasma. More specifically, since color gray-scale is controlled by using pulses of the plasma, it is difficult to execute multistage color gray-scale control.

As video equipment is more and more commonly digitalized and network technology centering on the Internet is improved recently, a cross-media system in which various units of video equipment are connected on an open system has come into wide use in earnest. In such open system, individual units of video equipment and applications must have a common interface to achieve a high general-purpose and extensible configuration. From the viewpoint of color reproducibility, a camera and a scanner, which are the types of video equipment for transmitting color information, have to perform accurate transmission of the captured color information to the open system. On the other hand, a display and a printer, which are the types of video equipment for receiving and displaying color information, have to perform accurate display of the received color information. For example, even when the camera accurately acquires the color information, the color reproducibility of the whole system deteriorates if the display displays the color information inaccurately.

To solve this problem, the IEC (International Electro-Technical Commission) formulated an sRGB system, which is the standard for a normal display. That is, by matching chromaticity points of three primary colors RGB with colorimetry parameters of Rec. 709 recommended by the ITU-R (International Telecommunication Union—Radiocommunication sector), the relation between a video signal RGB and a colorimetry value was clearly defined. Therefore, if the same video signal RGB is given to an arbitrary display according to the relevant normal display standard, the relevant display can colorimetrically display the same color. Displays are widely used not only for displaying images for viewing but also for editing images. For example, a display is used in a case of creating an original to be printed as a catalog. Consequently, the normal display “sRGB display” which can be colorimetrically managed is the main point of color management including a hard copy system such as printing.

Since the color range of the sRGB display is narrower than the color range of the NTSC (National Television System Committee) RGB determined for a cathode-ray tube (CRT) display, the technique for expressing a wider color reproduction range is disclosed in Japanese Patent Application Laid-Open No. H10-083149. In Japanese Patent Application Laid-Open No. H10-083149, a GaInP light-emitting diode (LED), of which the light emitting wavelength is 450 nm, a ZnCdSc LED, of which the light emitting wavelength is 513 nm, and an AlGaAs LED, of which the light emitting wavelength is 660 nm, are used as backlights for a liquid layer display. Here, it should be noted that color reproducibility of the backlights respectively using these LEDs is higher than that of the conventional CRT.

According to the standard of the normal display “sRGB display” determined, the color reproducibility was improved. Then, it has been proposed to improve color reproducibility by adding another color in addition to conventional red (R), green (G) and blue (B). More specifically, each of Japanese Patent Applications Laid-Open Nos. 2001-306023 and 2003-228360 discloses that sub-pixels to which cyan, magenta and yellow inks, in addition to conventional red (R), green (G) and blue (B) inks, are emitted are provided.

FIG. 8 is a diagram illustrating a light emission spectrum of cyan, in addition to light emission spectra of conventional red (R), green (G) and blue (B). In FIG. 8, a peak of light emission is set to “100”.

Besides, each of Japanese Patent Applications Laid-Open Nos. 2003-249174 and 2004-152737 discloses a technique for improving color reproducibility of a plasma display. More specifically, it is disclosed in each of these documents to improve color reproducibility by adding cyan-green in addition to conventional red (R), green (G) and blue (B). It should be noted that the conventional arts disclosed in these documents aim further to enlarge a color space because a color range defined by the sRGB is narrower than the color space perceivable by human eyes.

Moreover, Japanese Patent Application Laid-Open No. 2004-163817 discloses a technique for enlarging a color reproducible range on a projector to which second green has been added, in addition to conventional three projector display colors.

Incidentally, in Japanese Patent Application Laid-Open No. H10-083149, the color reproducibility of the backlight of the liquid-crystal display is improved. However, as illustrated in FIG. 4A, a color filter constituting a pixel 5 includes pixels of red (R) 7, green (G) 8 and blue (B) 9 respectively separated by a black matrix 6. That is, since color displaying is executed by the color filters of three colors, i.e., of red (R) 7, green (G) 8 and blue (B) 9, the expression of cyan is insufficient due to the characteristic of the color filter of green (G).

Further, Japanese Patent Application Laid-Open No. 2001-306023 discloses a technique for improving the expression of cyan due to the characteristic of the color filter. More specifically, in Japanese Patent Application Laid-Open No. 2001-306023, the sub-pixel (called “pixel” hereinafter) at least including cyan is provided to improve the color reproducibility. Here, the colors which constitute the pixel include magenta and yellow in addition to cyan, these being the three primary colors in a subtractive color mixing method. Furthermore, Japanese Patent Application Laid-Open No. 2003-228360 discloses a technique for improving a drawback in Japanese Patent Application Laid-Open No. 2001-306023. That is, in Japanese Patent Application Laid-Open No. 2003-228360, the luminance of cyan is made smaller than that of green (G) so as to achieve the “sRGB display”.

Also, each of Japanese Patent Applications Laid-Open Nos. 2003-249174 and 2004-152737 discloses that cyan-green is added to red (R), green (G) and blue (B).

For the display, an area of one pixel is determined from an area of a display screen and the number of total pixels. Further, each pixel element constituting a pixel is surrounded with the black matrix. For this reason, if the number of pixel elements is increased from three to four per pixel, the area of each pixel element becomes equal to or less than ¾ of the area of the pixel element of the three-pixel-element constitution.

If cyan, having low sensitivity (luminous efficacy or visibility) for human eyes, is added in the pixel, and if the area of each pixel element is further narrowed, it is impossible to avoid the problem that the average light emission efficiency deteriorates.

Unlike an active matrix driving TFT (thin film transistor) liquid crystal display and a plasma display, since a lighting-up time of one pixel is short in a simple matrix driving display such as an FED (Field Emission Display), if a primary color having low luminous efficacy is added, a problem of deteriorating luminance occurs. For this reason, it is difficult to satisfy both the luminance and the color reproducibility concurrently.

Moreover, in a projector disclosed in Japanese Patent Application Laid-Open No. 2004-163817, light acquired from a light source such as a lamp or the like is spectroscopically divided into two kinds of greens, and thus the color range of one pixel is enlarged by four colors, red, first green, second green and blue. For this reason, it is difficult to improve light emission efficiency by the spectroscopy of the two kinds of greens concurrently with meeting desired levels of both luminance and color reproducibility.

### SUMMARY OF THE INVENTION

An object of the present invention is to provide a display that can achieve a wide color reproduction range, high luminance and high-efficiency performance concurrently.

To achieve the above object, the present invention is characterized by a display which displays a color image by using a light source of at least four or more primary colors, wherein at least one color of the light source is yellow.

Further, the present invention is characterized by the display wherein the light source includes a fluorescent member.

Further features of the present invention will become apparent from the following description of exemplary embodiments with reference to the attached drawings.

### BRIEF DESCRIPTION OF THE DRAWINGS

FIG. 1 is a diagram illustrating a color reproduction range according to the present invention.

FIG. 2 is a diagram illustrating a luminous efficiency curve.

FIG. 3 is a diagram illustrating light emission spectra according to the present invention.

FIGS. 4A and 4B are diagrams respectively illustrating pixel shapes.

FIG. 5 is a schematic diagram illustrating an FED (Field Emission Display) according to the present invention.

FIG. 6 is a schematic cross-sectional diagram illustrating the FED according to the present invention.

FIG. 7 is a schematic cross section diagram illustrating an inorganic EL (electroluminescence) display according to the present invention.

FIG. 8 is a diagram illustrating conventional light emission spectra.

### DESCRIPTION OF THE EMBODIMENTS

In order to provide a display which can achieve a wide color reproduction range, high luminance and high-efficiency performance concurrently, the present invention is directed to a display which displays a color image by using a light source of at least four or more colors, wherein at least one color of the light source is yellow.

According to the present invention, it is possible to achieve a display of which the color reproduction area of display colors is wide and which is highly efficient.

The NTSC (National Television System Committee) RGB representing a wider color reproduction range has been determined rather than the sRGB as the chromaticity points of the RGB three primary colors. Further, it should be noted that the color reproduction range of the NTSC RGB is wider than the color reproduction range of the sRGB.

In regard to the NTSC RGB, red (0.670, 0.330), green (0.210, 0.710), blue (0.140, 0.080) and white (0.3101, 0.3162) have been determined as the CIE chromaticity coordinates. Likewise, in regard to the sRGB, red (0.640, 0.330), green (0.300, 0.600), blue (0.150, 0.060) and white (0.3127, 0.3290) have been determined as the CIE chromaticity coordinates. Further, the light emission efficiency has been determined based on the light emission intensity of white.

Since the color spaces of both the NTSC RGB and the sRGB are narrower than the color space perceivable by human eyes, it is necessary further to enlarge the color spaces of the NTSC RGB and the sRGB so as to achieve further improvement of color reproducibility.

In a case where four or more primary colors are used for a color display such as a flat panel display, in which the area of pixels is determined based on its screen size and the number of pixels, the present invention aims to provide a flat panel display that can acquire a wider color reproduction range without sacrificing luminance.

In order to provide a display that can achieve a wide color reproduction range, high luminance and high-efficiency performance concurrently, the present invention uses a light source (including a fluorescent member) of at least four or more colors, and at least one color of the light source is yellow.

That is, it is possible to improve the color reproduction range without sacrificing luminance, by using the four primary colors, having high luminous efficacy, of the chromaticity coordinates (0.640, 0.330) of yellow, having a wavelength of equal to or higher than 540 nm and equal to or lower than 570 nm, green, having a wavelength within the range of 505 nm to 520 nm, and red of the NTSC RGB, and the chromaticity coordinates (0.150, 0.060) of blue.

Ideally, it is possible to make a further enlargement of the color reproduction range by using red which satisfies {x≧0.67+α, y≦0.33−β}, where (α, β≧0) within the visible range of the CIE chromaticity coordinates, and blue which satisfies {x≦0.14−γ, x≧0.08−δ}, where (γ, δ≧0) within the visible range of the CIE chromaticity coordinates.

Here, it is preferable that blue is at least the blue represented by the NTSC RGB CIE chromaticity coordinates and red is at least the red represented by the red CIE chromaticity coordinates. However, it should be noted that blue and red are not limited to these particular choices, respectively.

Since yellow having a wavelength of equal to or higher than 540 nm and equal to or lower than 570 nm is close to the CIE chromaticity coordinates (0.210, 0.710) of green in the conventional NTSC RGB, it is possible to enlarge the color reproduction range by setting green to have a wavelength within the range of 505 nm to 520 nm.

Incidentally, the CIE chromaticity coordinates (x, y) of yellow are preferably to satisfy 0.24≦x≦0.45 and 0.56≦y≦0.76 outside a triangle of the CIE chromaticity coordinates (0.670, 0.330), (0.210, 0.710) and (0.140, 0.080) and within the visible range of the CIE chromaticity coordinates. Further, the CIE chromaticity coordinates (x, y) of green are preferable to satisfy x≦0.210 within the visible range of the CIE chromaticity coordinates and to be larger than “y” of the CIE chromaticity coordinates of yellow. Furthermore, “y” of the CIE chromaticity coordinates (x, y) of green is preferable to satisfy y≦0.710. In addition, the CIE chromaticity coordinates (x, y) of green are further preferable to satisfy x≦0.210 and y≧0.710, within the visible range of the CIE chromaticity coordinates, on the side opposite to the color reproduction range of the NTSC RGB in regard to the line segment between the color coordinates (x, y) and the CIE chromaticity coordinates (0.210, 0.710) of yellow, because the color reproduction range in this case completely covers the color reproduction range of the NTSC RGB.

Although the luminous efficacy of green is slightly deteriorated as compared with that of conventional green, it is possible to prevent deterioration of luminance by adding yellow of which the luminous efficacy is higher than that of conventional green.

In the following, the exemplary embodiments of the present invention will be described in detail.

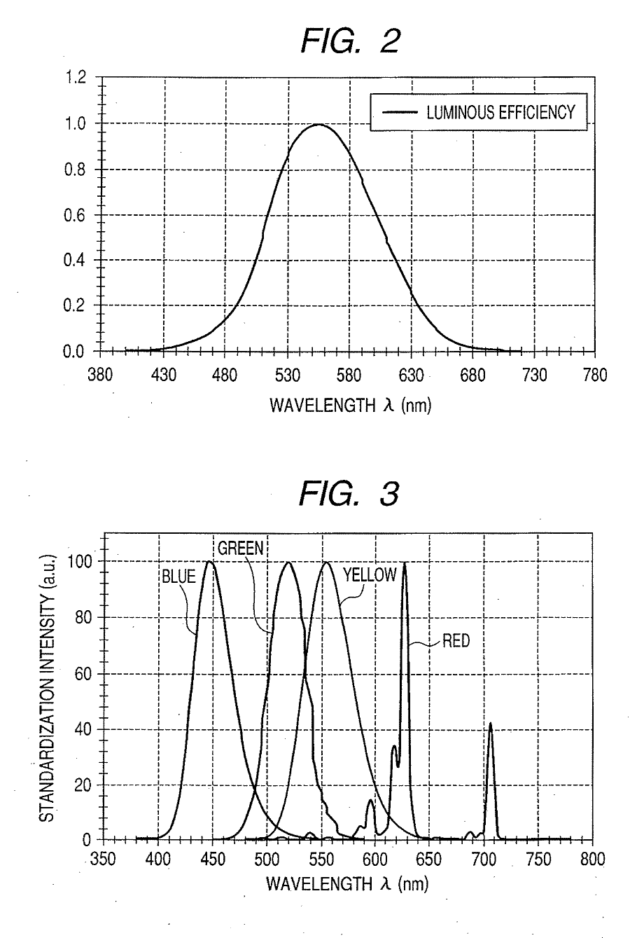

The display to be referred to in the exemplary embodiments is a display which displays a color image by four colors including, in addition to red (R), green (G) and blue (B), yellow (Y) having a light emission peak wavelength within a range of 540 nm to 570 nm, of which the standard luminous efficiency (see the standard luminous efficiency curve in FIG. 2, representing a relative change of luminous efficiency of human eyes) is high.

To make a further improvement in color reproducibility, it is preferable to set the peak wavelength of green (G) to 500 nm to 525 nm, this being shorter than the conventional peak wavelength of 525 nm to 535 nm.

In the case of the flat panel display, the area of one pixel is determined based on the area of the display screen and the number of total pixels, and each pixel element constituting the pixel is surrounded with a black matrix, and so it is difficult to achieve a large increase in the opening ratio of a light emission surface to maintain good contrast and suppress the influence of external light reflection as much as possible. For this reason, in the case of further adding a pixel element of another color to the three pixel elements of conventional three primary colors, the area of each pixel element becomes about ¾ of the area of the pixel element of the three-pixel-element construction.

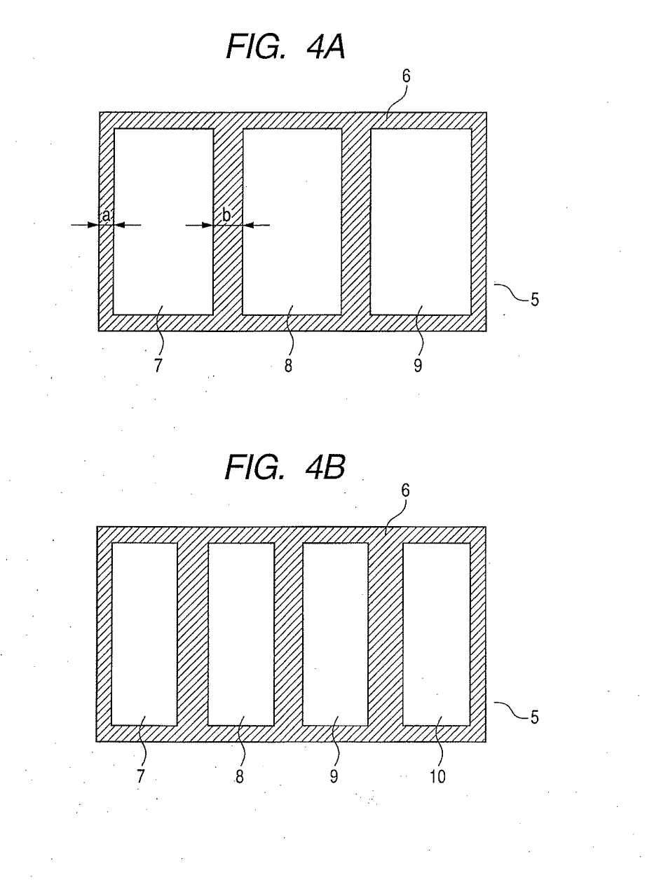

FIGS. 4A and 4B are diagrams each illustrating the pixel shape. More specifically, FIG. 4A illustrates the pixel in a case of using the conventional three primary colors. That is, as illustrated in FIG. 4A, the red pixel element 7 acting as the light emission range of red, the green pixel element 8 acting as the light emission range of green and the blue pixel element 9 acting as the light emission range of blue are formed with the black matrix 6 surrounding them. Here, it should be noted that the distance between the adjacent pixels can be arbitrarily set as indicated by “a” and “b” illustrated in FIG. 4A.

In such a conventional construction, if cyan, having low luminous efficacy, is added, the luminance becomes lower than that of the original three primary colors. On the other hand, as illustrated in FIG. 4B, if a yellow pixel element 10 acting as the light emission range of yellow and having high luminous efficacy is added, it is possible to enlarge the color range and also avoid deterioration of the luminance.

In the case of adding yellow, having high luminous efficiency, it is possible to make the area of yellow narrower than each of the areas of blue, green and red, each of which has luminous efficacy lower than the luminous efficacy of yellow. Further, if the light emission efficiency of the yellow is higher than each of the light emission efficiencies of blue, green and red, it is possible to increase the areas of blue, green and red by making the area of yellow still narrower or smaller, whereby it is thus possible to increase the overall luminance of a pixel.

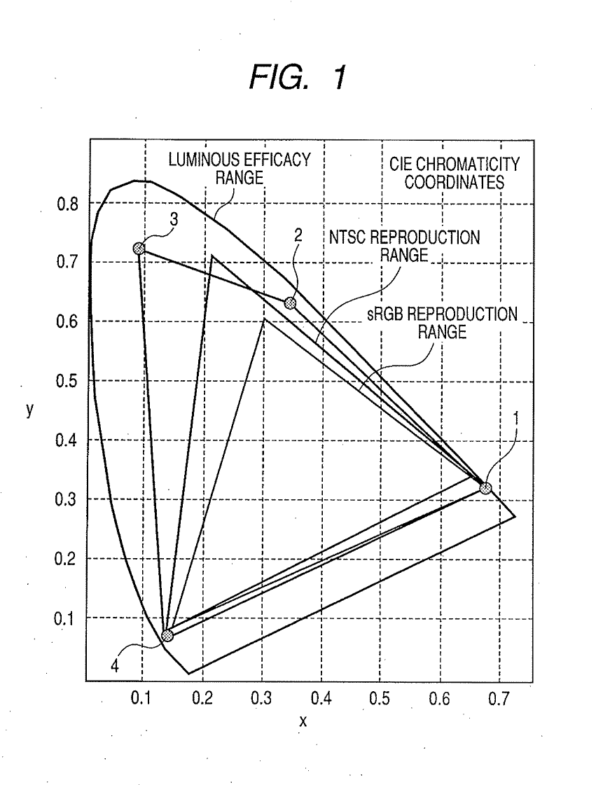

FIG. 1 is a diagram illustrating the CIE chromaticity coordinates in the case of using Y₂O₂S:Eu as a red fluorescent member, CaMgSi₂O₆:Eu as a blue fluorescent member, CaAl₂S₄:Eu as a green fluorescent member, and CaGa₂S₄:Eu as a yellow fluorescent member. Further, in FIG. 1, red at display point 1 has the light emission peak wavelength 625 nm and the CIE chromaticity coordinates (0.64, 0.34), yellow at display point 2 has the light emission peak wavelength 555 nm and the CIE chromaticity coordinates (0.34, 0.63), green at display point 3 has the light emission peak wavelength 520 nm and the CIE chromaticity coordinates (0.12, 0.71), and blue at display point 4 has the light emission peak wavelength 449 nm and the CIE chromaticity coordinates (0.15, 0.42). Here, it should be noted that, in the present exemplary embodiment, only the respective light emission colors are displayed, and the light emission wavelengths and the CIE chromaticity coordinates of these colors are measured by a spectroradiometer.

Incidentally, FIG. 1 illustrates the color ranges of the NTSC RGB and the sRGB for comparison.

In the multiprimary color display according to the present invention, since the peak wavelength of the light emission spectrum of green is set to 515 nm to 525 nm, the light emission efficiency of green slightly deteriorates. However, since yellow, of which the luminous efficiency is highest, is added, it is possible to suppress deterioration of the light emission efficiency of the pixel as a whole, and it is thus possible to achieve high luminance.

Moreover, by combining the four colors red, yellow, green and blue illustrated in FIG. 1, it is possible to maintain high luminance and further express a wide color range as compared with a conventional three primary color display or a conventional multiprimary color display.

Incidentally, to maintain high luminance, yellow, of which the luminous efficacy is higher than those of the three primary colors of red, green and blue (also simply called “R”, “G” and “B” hereinafter), is added to R, G and B to be able to acquire the wide color range. Further, to enlarge the color range, the CIE chromaticity coordinates of yellow are preferably to be outside the line segment between R and G of the triangle of R, G and B on the CIE chromaticity coordinates of the NTSC RGB and to be within the visible range of the CIE chromaticity coordinates. In this case, the peak wavelength of light emission is preferably to be equal to or higher than 540 nm and equal to or lower than 570 nm, corresponding to a luminous efficiency of 0.92 or higher. Furthermore, on the CIE chromaticity coordinates, yellow is preferably to satisfy 0.24≦x≦0.45 and 0.56≦y≦0.76.

Moreover, the CIE chromaticity coordinates (x, y) of green are preferably to satisfy, within the visible range of the CIE chromaticity coordinates, x≦0.2 and to be larger than “y” of the CIE chromaticity coordinates of yellow, and, further, preferably to satisfy y≦0.710. In addition, “y” of the CIE chromaticity coordinates is preferably to be larger than 0.710, and to be within the visible range of the CIE chromaticity coordinates, on the side opposite to the color reproduction range of the NTSC RGB in regard to the line segment between yellow and the CIE chromaticity coordinates (0.210, 0.710) of green of the NTSC RGB, because the color reproduction range in this case completely covers the color reproduction range of the NTSC RGB.

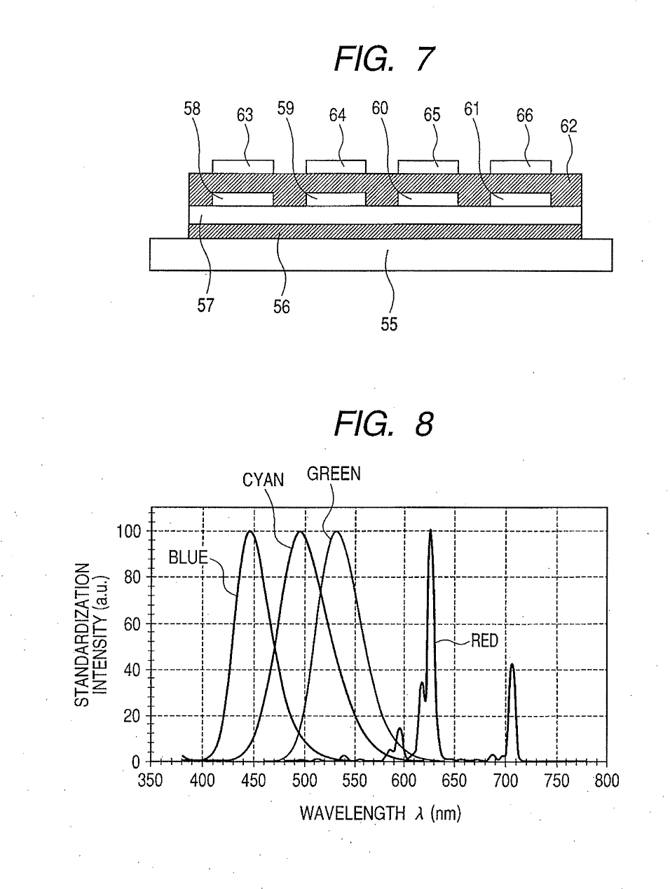

As the display, a plasma display or an FED for emitting light by using a fluorescent material, an inorganic EL display illustrated in FIG. 7, or an organic EL display (not illustrated) is applicable.

In the case of a liquid crystal display, the color range of a backlight is set to the configuration illustrated in FIG. 1, and a yellow color filter is used in addition to red, blue and green color filters. Thus, it is possible to achieve the same effect as that achieved by a natural light display.

Subsequently, the construction of the EL display will be described based on the inorganic EL display, with reference to FIG. 7.

In the inorganic EL display illustrated in FIG. 7, a transparent electrode 56 and a first dielectric film 57 are formed on a glass substrate 55. Further, an inorganic light emission film 58 for emitting red light, an inorganic light emission film 59 for emitting blue light, an inorganic light emission film 60 for emitting green light and an inorganic light emission film 61 for emitting yellow light are formed on the first dielectric film 57.

Furthermore, a second dielectric film 62 is formed so as wholly to cover the inorganic light emission films 58, 59, 60 and 61. On the second dielectric film 62, transparent electrodes 63, 64, 65 and 66 are formed respectively at locations corresponding to the respective inorganic light emission films 58, 59, 60 and 61.

If a voltage is applied to or an electron beam or ultraviolet light is irradiated onto the fluorescent member, the fluorescent member fluoresces. For this reason, the fluorescent member can be applied to a flat panel display of a type that applies a voltage to control each pixel, such as the inorganic EL display, an electron beam induction display, onto which an electron beam is irradiated, and a plasma display, which emits ultraviolet light in a pixel space.

Incidentally, a cold cathode discharge tube and light emission diodes are used for the backlight of the liquid crystal display. Here, the cold cathode discharge tube, which irradiates an electron beam from a cold cathode onto a fluorescent member, operates based on the same principle as that of the electron beam induction display, and so it is possible to enlarge the color range by using the fluorescent member for emitting yellow light in addition to the fluorescent members for emitting R, G and B lights.

In the case of using light-emission diodes, it is possible to enlarge the color range by properly combining the light-emission diode for emitting yellow light with the light-emission diodes for respectively emitting R, G and B light. Further, it is only necessary to combine fluorescent members for respectively emitting R, G and B light and a fluorescent member for emitting yellow light by receiving ultraviolet light, with a diode for emitting ultraviolet light. In this case, it is possible to construct a white light-emission diode by combining the fluorescent member for emitting R, G, B or yellow light with the one ultraviolet light-emission diode, or by combining the fluorescent members for respectively emitting R, G, B and yellow light with the one ultraviolet light-emission diode.

As the material of the fluorescent member for emitting yellow light, fluorescent member materials described by CaGa₂S₄:Eu and Ca—SiAlON:Eu and having a peak of light emission wavelength within the range of 540 nm to 570 nm are used.

Further, as the material of the fluorescent member for emitting green light, fluorescent member materials described by CaAl₂S₄:Eu, EuAl₂S₄, BaSi₂S₅:Eu and the like and preferably having a peak of light emission wavelength within the range of 500 nm to 520 nm are used.

However, the fluorescent member materials for emitting yellow and green light are not limited to those described above. That is, any fluorescent member material can be used provided that the chromaticity coordinates of yellow and green according to the present invention are obtainable.

Moreover, as the material of the fluorescent member for emitting blue light, fluorescent member materials described by, for example, ZnS:Ag,Cl, BaMgAl₁₀O₇:Eu, SrGa₂S₄:Ce and the like are used. In addition, as the material of the fluorescent member for emitting red light, fluorescent member materials described by, for example, Y₂O₂S:Eu, Y₂O₃:Eu, CaS:Eu and the like are used. That is, an optimum material can be selected according to the particular display method to be used and the characteristics it is desired to achieve.

FIG. 3 is a diagram illustrating light-emission spectra in the case of using Y₂O₂S:Eu for red, CaAl₂S₄:Eu for green, CaGa₂S₄:Eu for yellow, and ZnS:Ag,Cl for blue. Here, it should be noted that the light-emission spectra illustrated in FIG. 3 are given by standardizing the maximum light-emission luminance of each fluorescent member to “1”.

If yellow is added to R, G and B, as illustrated in FIG. 3, the display according to the present invention displays white by adding yellow as a light-emission color to the light-emission colors red, green and blue, then it is necessary to increase the luminance of blue.

In the meantime, since yellow, having high light-emission efficiency, is added, it is possible to display white by decreasing the light-emission luminance of yellow, which has the maximum light emission efficiency, and subsequently decreasing the light-emission luminance of green.

For this reason, in the case of displaying white, it is possible to increase the light-emission efficiency of the pixel by enlarging the light-emission area of blue and meanwhile decreasing the light-emission areas of other display colors.

Further, from the same point of view, in order to achieve a further increase in the light-emission efficiency, it is effective to increase the luminance of red, which has a low luminous efficiency, as illustrated in FIG. 2.

According to such results as described above, if the areas of the light-emission ranges in one pixel are set to be wide in the order of yellow, green, red and blue, it is possible to increase the light-emission efficiency as effectively using the light-emission areas in the pixel.

For example, in an FED which uses Y₂O₂S:Eu for red, CaAl₂S₄:Eu for green, CaGa₂S₄:Eu for yellow and ZnS:Ag,Cl for blue, it is possible to increase the light-emission efficiency by about 60% by multiplying red by 1.10, multiplying yellow by 0.73, multiplying green by 0.90 and multiplying blue by 1.27, as compared with the case in which the areas displaying respective light-emission colors are identical to each other.

### EXAMPLES

In the following, the present invention will be instantiated in detail.

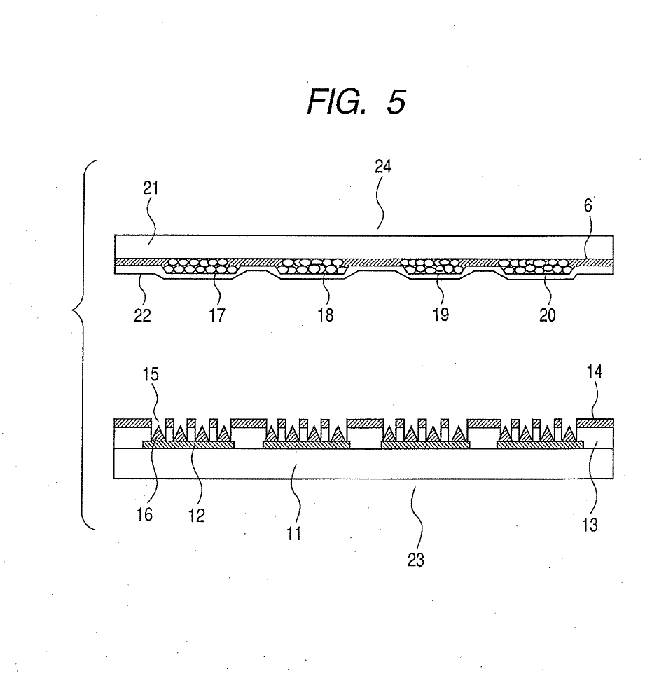

An FED (Field Emission Display) as illustrated in FIG. 5 is manufactured.

First, a method of manufacturing a rear plate (that is, the substrate on an electron emission source side) 23 will be described.

Then, aluminum of 200 nm is formed as a cathode electrode 12 on a glass substrate 11 by a sputtering method. Next, silicon dioxide of 600 nm is formed as an insulating layer 13 by a CVD (chemical vapor deposition) method, and a titanium film of 100 nm is formed as a gate electrode 14 by a sputtering method.

Subsequently, an opening 15 having a diameter of 1 μm is formed on the gate electrode and the insulating layer by photolithography and etching processes.

Subsequently, the above manufactured substrate is set within a sputtering device, and vacuum discharging is executed. Then, to form an electron emission unit 16, molybdenum is deposited diagonally while the substrate is rotated. After that, the excessive molybdenum is lifted off, whereby the electron emission unit is formed.

Incidentally, although the above manufacturing process is explained with respect to the range corresponding to one pixel, the above construction is actually arranged like a matrix on the substrate.

Next, a method of manufacturing a faceplate (fluorescent surface) 24 will be described.

First, a black matrix 6 is formed on a glass substrate 21 through screen printing. At this time, a fluorescent member application range is provided.

Next, fluorescent powder is dispersed to a binder or the like, impasted, and then applied likewise through the screen printing, whereby fluorescent films 17, 18, 19 and 20 are formed in the fluorescent member application range.

Subsequently, through a filming process, aluminum of 100 nm is deposited as a metal back 22 by a deposition method, whereby the faceplate 24 is formed. Incidentally, although the above manufacturing process is explained with respect to the range corresponding to one pixel, the above constitution is actually arranged like a matrix on the substrate.

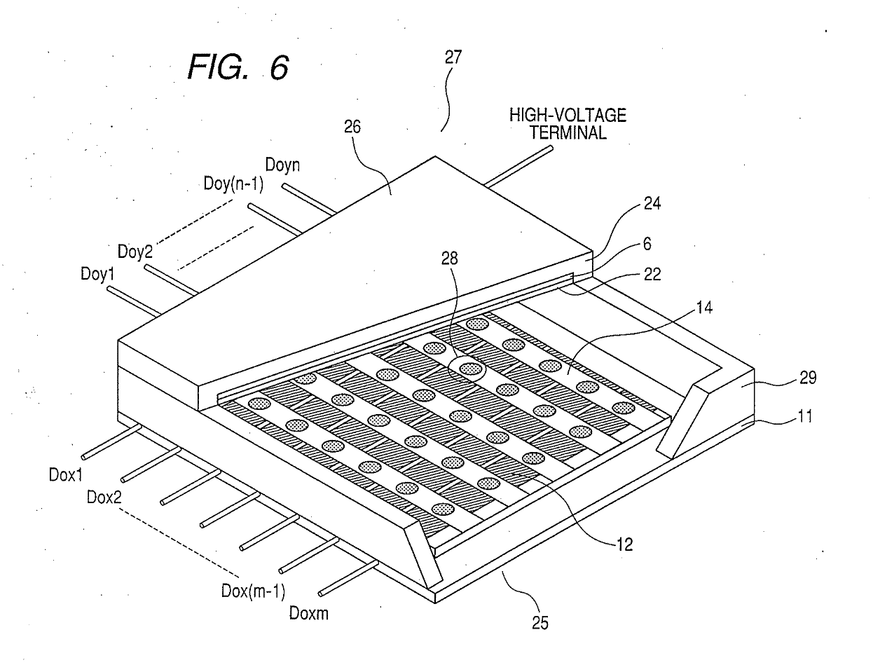

The rear plate 23 and the faceplate 24 which were manufactured as above are properly combined with each other, thereby manufacturing an FED 27 as illustrated in FIG. 6.

An electron emission unit 28 is provided in the range wherein the cathode electrode 12 and the gate electrode 14 intersect. In this range, the electron emission unit in which four ranges respectively corresponding to red, green, blue and yellow illustrated in FIG. 5 are separated is formed. Further, a support frame 29 is located at the joint of rear plate 25 and faceplate 26 illustrated in FIG. 6.

A high-voltage applying terminal is connected to the faceplate 26, and an applying voltage is set to be 10 kV.

On the rear plate 25, signal input terminals Dox1 to Doxm are connected to the cathode electrode 12, and signal input terminals Doy1 to Doyn are connected to the gate electrode 14. In the circumstances, signals supplied from a driving driver are input to the respective signal input terminals.

### Example 1

The FED is manufactured by the fluorescent members of four primary colors including yellow in addition to R, G and B.

In this case, Y₂O₂S:Eu for red, CaAl₂S₄:Eu for green, ZnS:Ag,Cl for blue, and CaGa₂S₄:Eu for yellow are used as the fluorescent member materials.

Here, the areas of the light-emission ranges of respective colors are set to be identical.

### Comparative Example 1

In this case, Y₂O₂S:Eu for red, CaAl₂S₄:Eu for green, and ZnS:Ag,Cl for blue are used as the fluorescent member materials.

Also, in this case, the areas of the light-emission ranges of respective colors are set to be identical.

### Comparative Example 2

In this case, Y₂O₂S:Eu for red, CaAl₂S₄:Eu for green, ZnS:Ag,Cl for blue, and BaGa₂S₄:Eu for cyan are used as the fluorescent member materials.

Here, the areas of the light-emission ranges of respective colors are set to be identical.

Generally, the light-emission efficiency in the display is calculated based on the luminance in the case of displaying white having a certain standard. In this case, the light-emission efficiency is calculated based on the CIE chromaticity coordinates (0.3101, 0.3162) of white represented by an NTSC signal.

That is, the light-emission efficiency is derived from acquired white luminance and input power.

In the color reproduction range in the example 1, the range of 120% for the display range by the NTSC signal can be expressed. In the color reproduction range, the areas plotted as illustrated in FIG. 1 are compared with others on the CIE chromaticity coordinates.

The luminance in the example 1 is 0.9 times the luminance in the comparative example 1, and the luminance in the comparative example 2 is 1.2 times the luminance in the comparative example 1.

The light-emission efficiency in the example 1 can be increased by about 25% as compared with the light-emission efficiency in the comparative example 2.

In the example 1, the color reproduction range is 124% of the color reproduction range displayed based on the NTSC signal. Further, the color reproduction range in the comparative example in which cyan has been added is 110% of the color reproduction range displayed based on the NTSC signal.

Furthermore, the luminance of the display according to the present invention is increased by 24% as compared with the four primary color FED in which cyan has been added.

### Example 2

The four primary color FED is manufactured in the same manner as that in Example 1.

In Example 1, the areas of the respective pixel elements are set to be identical. However, in Example 2, the red light-emission range is set to be 0.9 times the red range in Example 1, the green light-emission range is set to be 0.9 times the green range in Example 1, the blue light-emission range is set to be 1.3 times the blue range in Example 1, and the yellow light-emission range is set to be 0.9 times the yellow range in Example 1. The FED is manufactured under this condition.

The display color range of the FED thus manufactured is 124% of the color reproduction range displayed based on the NTSC signal. Further, the light-emission luminance is increased by 46% as compared with the light-emission luminance in Example 1.

### Example 3

The four primary color FED is manufactured in the same manner as that in Example 1.

However, in Example 3, the red light-emission range is set to be 1.1 times the red range in Example 1, the green light-emission range is set to be 0.9 times the green range in Example 1, the blue light-emission range is set to be 1.28 times the blue range in Example 1, and the yellow light-emission range is set to be 0.72 times the yellow range in Example 1. The display unit for one pixel is manufactured under this condition. Incidentally, the design of each light-emission range is acquired by converting the value calculated by adjusting the luminance of each color to satisfy the CIE colorimetry coordinates of designed white when the same power is supplied.

The display color range of the FED thus manufactured is 124% of the color reproduction range displayed based on the NTSC signal. Further, the light-emission luminance is increased by 59% as compared with the light-emission luminance in Example 1 manufactured for comparison.

The examples using the FED are described as above. In the following, an example using the inorganic EL display will be described.

### Example 4

The EL panel according to the present invention is manufactured by using the EL element as illustrated in FIG. 7.

An ITO (Indium Tin Oxide) film of 100 nm is formed as the transparent electrode 56 on the glass substrate 55 by the sputtering method. Further, a Ta₂O₅ (Tantalum oxide powder) of 200 nm is formed as the first dielectric film 57 on the transparent electrode 56 similarly by using the sputtering method.

Subsequently, the fluorescent member films 58, 59, 60 and 61 are formed on the first dielectric film 57.

Here, the fluorescent member thin film is formed by an EB (Electron Beam) deposition device having two electron beam sources.

First, the fluorescent member films are set to be 0.5 μm entirely. Then, as the fluorescent members, CaS:Eu is used for the fluorescent member thin film 58 for emitting red light, CaAl₂S₄:Eu is used for the fluorescent member thin film 59 for emitting green light, SrGa₂S₄:Eu is used for the fluorescent member thin film 60 for emitting blue light, and CaGa₂S₄:Eu is used for the fluorescent member thin film 61 for emitting yellow light.

The thin film formed like this is held at 800° C. for 30 minutes within a 2% hydrogen sulfide atmosphere diluted by argon, so as to execute a crystallization process.

Next, on the above fluorescent member film, Ta₂O₅ of 200 nm is deposited as the second dielectric film 62 by the sputtering method.

Subsequently, such a multilayer substrate as described above is subjected to a heating process at 700° C. for ten minutes within an Ar atmosphere, and, after that, the transparent electrodes 63, 64, 65 and 66 of 200 nm are formed respectively at locations corresponding to the respective fluorescent member films on the second dielectric film 62 by the sputtering method.

Then, the light-emission characteristics of the EL panel element thus manufactured are evaluated.

More specifically, a signal of which the frequency is 1 kHz and the pulse width is 20 psec is applied between the transparent electrode 56 and the transparent electrodes 63, 64, 65 and 66 on the EL panel element, and then the color reproduction range and the luminance are observed.

As a result, the color reproduction range is enlarged by 28% as compared with the color reproduction range of the conventional NTSC signal. In addition, the luminance of 500 cd/m² can be acquired.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-140881, filed May 19, 2006, which is hereby incorporated by reference herein in its entirety.

1. A display which displays a color image by using a light source of at least four or more primary colors, wherein at least one color of the light source is yellow.

2. A display according to claim 1, wherein the light source includes a fluorescent member.

3. A display according to claim 1, wherein the four or more primary colors are fluorescence-emitted by a fluorescent member that is subjected to irradiation by an electron beam, application of a voltage, or irradiation by ultraviolet light.

4. A display according to claim 1, wherein CIE chromaticity coordinates (x, y) of yellow satisfy 0.24≦x≦0.45 and 0.56≦y≦0.76 outside a triangle of the CIE chromaticity coordinates (0.670, 0.330), (0.210, 0.710) and (0.140, 0.080) and within a visible range of the CIE chromaticity coordinates.

5. A display according to claim 4, wherein the CIE chromaticity coordinates (x, y) of green satisfy x≦0.210 within the visible range of the CIE chromaticity coordinates and is larger than “y” of the CIE chromaticity coordinates of yellow.

6. A display according to claim 5, wherein “y” of the CIE chromaticity coordinates (x, y) of green satisfies y≦0.710.

7. A display according to claim 4, wherein the CIE chromaticity coordinates (x, y) of green satisfy x≦0.210 and y≧0.710 within the visible range of the CIE chromaticity coordinates, on the side opposite to a color reproduction range of an NTSC RGB in regard to a line segment between the color coordinates (x, y) and the CIE chromaticity coordinates (0.210, 0.710) of yellow.

8. A display according to claim 1, wherein luminous efficiency of yellow is higher than luminous efficiencies of red, green and blue.

9. A display according to claim 1, wherein an area of a blue light-emission range in one pixel is wider than areas of red, green and blue light-emission ranges.

10. A display according to claim 1, wherein areas of light-emission ranges in one pixel satisfy the following relation: an area of a blue light-emission range>an area a of red light-emission range>an area of a green light-emission range>an area of a yellow light-emission range.
